(19) United States
(12) Patent Application Publication
(10) Pub. No.: US 2019/0236122 A1
(43) Pub. Date: Aug. 1, 2019

(54) System, Method and Frameword for Building a Website

(71) Applicants: Sean Montgomery, Burbank, CA (US); Jacques Antikadjian, Burbank, CA (US)

(72) Inventors: Sean Montgomery, Burbank, CA (US); Jacques Antikadjian, Burbank, CA (US)

(21) Appl. No.: 15/886,803

(22) Filed: Feb. 1, 2018

(51) Int. Cl. G06F 17/22; G06F 17/30; G06F 3/0482; G06F 3/0484

(52) U.S. Cl. CPC G06F 17/2247; G06F 17/30572; G06F 3/04847; G06F 3/0482; G06F 17/3089

(57) ABSTRACT

The present invention discloses a system, method and framework for developing and managing a website, wherein the website is configured for unlimited growth and scaling by adding, deleting and modifying pre-cast data requirements responsive to the needs of the website.

### PRIORITY CLAIM

This application claims the benefit of U.S. Provisional Patent Application No. 61/913,385, filed Dec. 9, 2013, titled “System, Method and Framework for Building a Website.

### FIELD OF THE INVENTION

The present invention relates to a system, method and framework for building a website. Specifically, the present invention allows a website to be created, supplemented, updated and mined by an individual with rudimentary knowledge and skill in website development and computer languages.

### BACKGROUND ART

The proliferation of the internet and intranets has led to an increasing demand for the creation of websites. A website typically includes a collection of web pages developed to include content, such as text, graphics, or other multimedia material, as well as other features such as links and buttons. Creating a website typically requires generating a plurality of pages using a programming language, like PHP, ASP, Python, Java, etc., to generate the markup language [e.g. Hypertext Markup Language (“HTML”), XML, RSS, or others (programming language and/or templating language and/or markup language are hereafter collectively referred to as “code” or “coding”)]. In addition, the use of a templating language (e.g. Clearsilver, Smarty, Twig, etc.) may also be utilized to generate markup language used to create website pages. Adding content to a website once created, or modifying the website involves using code. This makes it difficult for individuals without specific code knowledge to create, supplement, modify or query a website.

Another problem with existing systems is that when using code to create a web page, the creator (programmer) of the code may accomplish an end function for the website using methods specific to the creator. This inconsistency in methods from creator to creator, and the lack of a structured framework for accomplishing functions has led to a hodgepodge of programming code, which is invisible to the common end user, and frustrating to creators. Unfortunately, as methodologies for writing code mature and creators discover more efficient means for building websites, the underlying code becomes antiquated and unfamiliar to secondary creators.

Additional complexities arise when several creators collaborate on the development of a website, incorporating their own code writing methods. For example, one or more creators may craft the code behind the text for a page, another creator may be responsible for graphics, another may be responsible for database queries, while yet another creator may add appropriate legal notices (e.g., trademark or copyright notices), etc.

Accordingly, existing website development systems have many drawbacks, which often require businesses to employ or contract the services of one or more expert programmers, which can be extremely costly. Moreover, with complex website development systems, programmers must be used every time a website requires maintenance or modification. Since web content may need to change frequently and quickly, in response to business needs, updates can be costly and may require website downtime. In addition, as methods for writing code may vary from programmer to programmer, businesses may be bound to use the same programmer to ensure consistency, and ensure additional resources aren't spent deciphering and/or modifying a previous programmer's code.

Currently, the method for building a website is left up to the programmer. Although this freedom of expression has spurred creativity and allowed variances to the unknown degree, it is exactly this byproduct of creativity that has led to massive inconsistencies in code from website to website and within code in a single website. Programmers use their creativity to meet the functional demands of website owners, which leads to a bevy of different solutions from different programmers. Although an end webpage may be similar in appearance and functionality, the code for rendering the webpage may vary grossly, and as websites become more and more complex, the unseen code supporting the webpages also develop in complexity and volume. It is precisely this inconsistency and lack of a framework that frustrates businesses when they need to update or maintain their websites.

Attempts have been made to provide improved systems for developing websites in which the need for code programming is minimized. However, such attempts, generally fail to provide a framework to develop, supplement, update and query a website essentially free from the need of programming skill. That is, advanced knowledge of code programming is still required.

Compounding existing deficiencies in the current state of the art is their inability to offer various growth, functionality, query and other capabilities necessary in growing the website in the direction most pertinent to the business goals. As business goals and objectives change often and as a result of customer demands, the website needs to be scalable in any direction the business deems necessary. Existing methods fail to provide the capacity for further website growth and/or maintenance and scalability. As the website grows and additional extensions and/or functionality is required, the current state of the art is not configured to adapt to the website owner's needs. Common extensions may include an ecommerce element, a blog, or a polling system. The addition or expansion of the existing website to include extensions is often impossible, or very costly, because the underlying code wasn't built to support such expansions. Further exacerbating the problem is the fact that extensions, generally provided and written by third parties, are developed by different creators, each incorporating their own methodologies for programming.

These and many other features are limited in existing systems and, accordingly, a need exists for an improved system, method and framework for building a website.

### SUMMARY OF THE INVENTION

The present invention generally relates to a system and method for developing and maintaining a website. Specifically, the present invention allows a website to be developed and maintained incorporating a framework for the website, as well as components (termed “data requirements”) which are added to the framework. The data requirements are selected from a pool of data requirements, and are selected to address the specific needs of a given website. In addition, the framework and data requirements may be incorporated without the need of an expert (e.g., code) programmer. In general, the present invention allows creators of the website to hand pick components that are relevant to the specific type of website they are building, and populate the website with content without the need to write and/or edit code. This allows for creation, modification, updating and manipulation of content on the website without the use or knowledge of code.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a Data Requirement Framework in accordance with an embodiment or portion of an embodiment of the present invention.

FIG. 2 depicts exemplary components for a Data Requirement Framework with an embodiment or portion of an embodiment of the present invention.

FIG. 3 depicts a flow chart for configuring the Data Requirement Framework in accordance with an embodiment or portion of an embodiment of the present invention.

FIG. 4 depicts a flow chart for detailing various aspects of a Data Requirement Framework in accordance with an embodiment or portion of an embodiment of the present invention.

FIG. 5 depicts a flow chart for detailing various aspects of a Data Requirement Framework in accordance with an embodiment or portion of an embodiment of the present invention.

FIG. 6 depicts an exemplary graphic user interface in accordance with an embodiment or portion of an embodiment of the present invention.

FIG. 7 depicts an exemplary graphic user interface in accordance with an embodiment or portion of an embodiment of the present invention.

FIG. 8 depicts an exemplary graphic user interface in accordance with an embodiment or portion of an embodiment of the present invention.

FIG. 9 depicts an exemplary graphic user interface in accordance with an embodiment or portion of an embodiment of the present invention.

FIG. 10 depicts an exemplary graphic user interface in accordance with an embodiment or portion of an embodiment of the present invention.

FIG. 11 depicts an exemplary graphic user interface in accordance with an embodiment or portion of an embodiment of the present invention.

FIG. 12 depicts an exemplary graphic user interface in accordance with an embodiment or portion of an embodiment of the present invention.

FIG. 13 depicts an exemplary graphic user interface in accordance with an embodiment or portion of an embodiment of the present invention.

FIG. 14 depicts an exemplary schema in accordance with an embodiment or portion of an embodiment of the present invention.

FIG. 15 depicts an exemplary populated data field of a Data Requirement Framework in accordance with an embodiment or portion of an embodiment of the present invention.

FIG. 16 depicts an exemplary data conversion output of a Data Requirement Framework in accordance with an embodiment or portion of an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention provides a system and method for developing and managing a website with unlimited scalability and adaptability, all without the creator having to program code. It allows the creator of a website to pick and choose existing data requirements that are relevant to the creator's website, wherein the data requirement are pre-existing and provided by the system. In addition, the present invention provides for unlimited scalability and adaptability by allowing the addition and removal of data requirements to the framework without issue. Finally, the inventive system and method provided herein allows for manipulation of content on the website without the need to code, by allowing for simple manipulation of options found on the pre-existing data requirements to meet the website's goal or purpose.

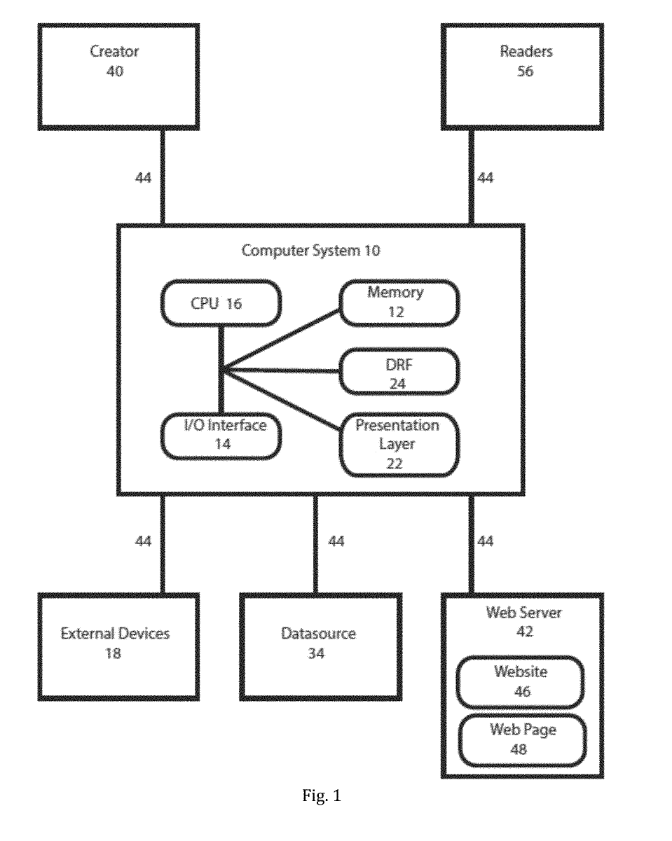

Referring now to FIG. 1, the invention is configured to operate on a computer system 10 which generally comprises memory 12, an input/output (I/O) interface 14, a central processing unit (CPU) 16, an external device/resource 18, a bus 20, and a datasource 34. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. The CPU 16 may comprise a single processing unit, or be distributed across one or more processing units in one or more locations, e.g., on a client and server. An I/O interface 14 may comprise any system for exchanging information from an external source. An external device 18 may comprise any known type of external device, including speakers, a CRT, LED screen, hand-held device, keyboard, mouse, voice recognition system, speech output system, printer, monitor, facsimile, pager, etc. The external device 18 would ideally communicate and/or relay information to/with the viewer or reader of the website (hereafter referred to as reader 58). The bus 20 provides a communication link between each of the components in the computer system 10 and likewise may comprise any known type of transmission link, including electrical, optical, wireless, etc. In addition, although not shown, other components, such as cache memory, communication systems, system software, etc., may be incorporated into the computer system 10.

The computer system 10 also incorporates a layer 22 to functionally relay the website created on the Data Requirement Framework 24 (“DRF”). A creator 40 (includes creators, editors, developers, and administrators) utilizes the computer system 10 to develop the website 46, and publishes the website for viewing/reading by the reader 58 via the presentation layer 22.

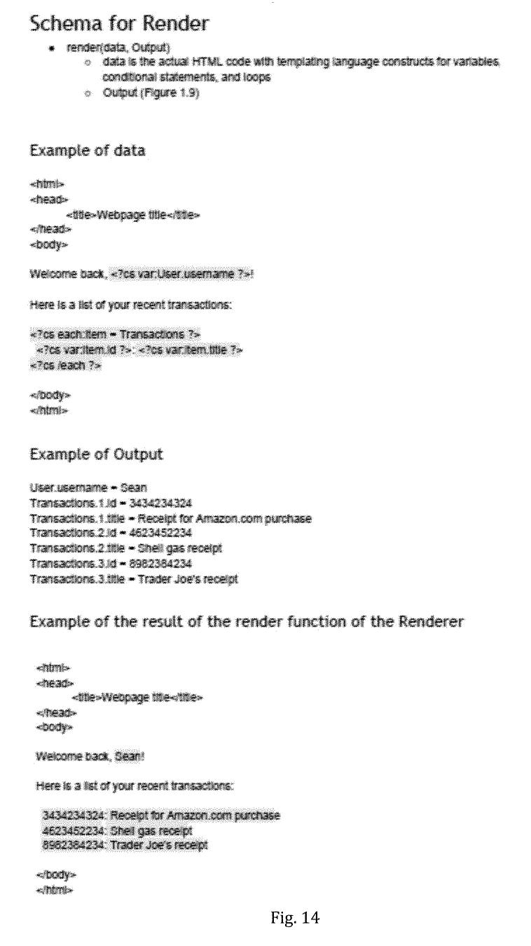

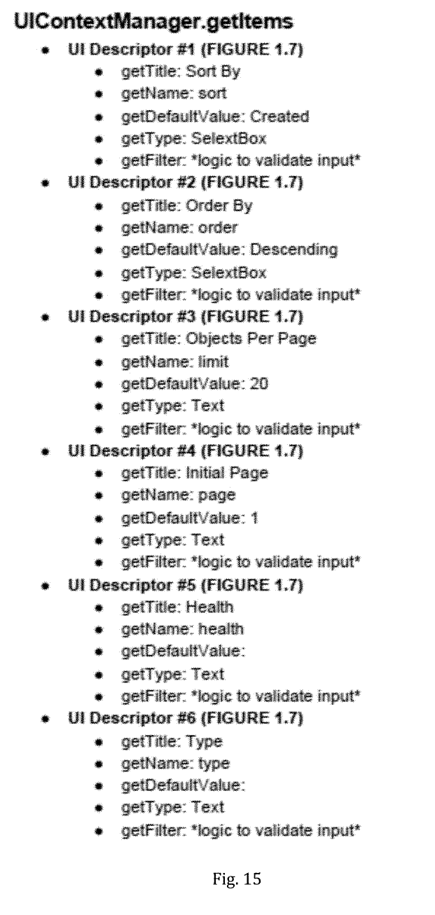

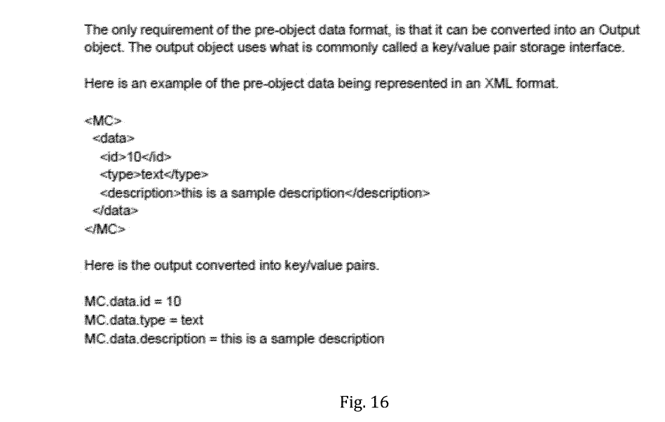

The datasource 34 provides storage for information necessary to execute elements of the present invention. Such information could include: content; creator identifications and roles; subscribed readers 58; web page categories; creator groups; website update records; reader feedback; and creator group-category assignments. Datasource 34 may include one or more storage devices, such as a magnetic disk drive or an optical disk drive. In another embodiment, the datasource 34 includes data distributed across, for example, a local area network (LAN), wide area network (WAN) or a storage area network (SAN) (not shown). Datasource 34 may also be configured in such a way that one of ordinary skill in the art may interpret it to include one or more storage devices. Moreover, it should be understood that datasource 34 could alternatively exist within the computer system 10. Stored in memory 12 is the presentation layer 22 and the Data Requirement Framework 24. Under the present invention, creators 40 will formulate content in a non-code format for publishing to the website 46 using the Data Requirement Framework 24. The Data Requirement Framework 24 will convert the content into a data model (hereafter referred to as output object) used by a templating engine (hereafter referred to as renderer) to generate data for a specific purpose, such as: markup language data for a web page (See FIG. 14), markup language data for an XML document, machine readable data for software and/or hardware applications, derivatives thereof, and combinations therefrom. This data can optionally be loaded onto a web server 42 for consumption by readers 58, software applications, hardware applications, derivatives thereof, and combinations therefrom. It should be understood that the web server 42 is optional and that computer system 10 could be a web server in and of itself. In this case, the loading of this data to a separate system would be unnecessary.

Communication amongst the computer system 10 and web server 42 (if implemented) occurs via communication links 44. Communications links 44 can include a direct hardwired connection (e.g., serial port), or an addressable connection such as a remote system in a client-server environment. In the case of the latter, the client and server may be connected via the Internet, wide area networks (WAN), local area networks (LAN) or other public or private networks. The server and client may utilize conventional token ring connectivity, ethernet, or other conventional communications standards. Where the client is connected to the system server via the internet, connectivity could be provided by conventional TCP/IP sockets-based protocol. In such instance, the client would need to utilize an internet service provider outside the system to establish connectivity to the system server within the system.

It is understood that the present invention can be realized in hardware, software, or a combination of hardware and software. Moreover, the computer system 10 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein—is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which, when loaded in a computer system, is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

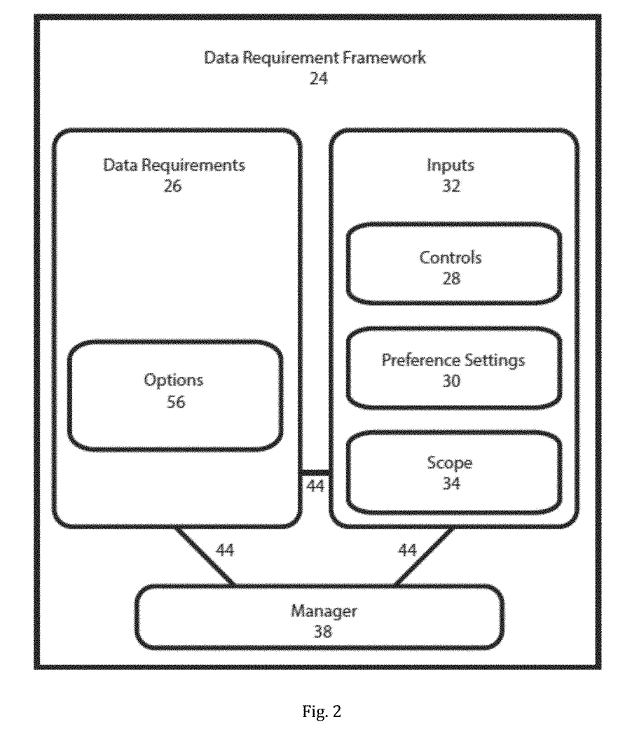

FIG. 2 depict various components of the DRF 24, which includes data requirements 26, inputs 32 (including controls 28, preference settings 30, and scope 34) and a manager 38, which perform the various features to be described below. It should be understood that each of these sub-systems include interfaces for creators 40 to interact with the DRF 24. Although certain interfaces will be detailed herein for exemplary purposes, it should be understood that the detailed interfaces are not exhaustive, and other interfaces that have not been mentioned herein could be implemented.

The DRF 24 provides the basis for enabling a website creator 40 to populate a website 46 using a plurality of pre-existing flexible tools, features, plug-ins and other substance (each one hereafter referred to as a “data requirement”) that are applicable to the function of the website. This dynamic library of configurable data requirements 26 each incorporates a catalogue of options 56 relevant to each specific data requirement 26. These options 56 are configured and personalized by the creator 40 to meet the specific needs of the website 46.

Exemplary options 56 include order, number of items, sorting, and filtering selections (e.g. staff favorites and popular objects) to name a few. The configurable data requirements 26 are devised to enable customization of the website. A library may comprise fields, some of which may be designated as required fields. For example, one feature of a website may be a list of page content. An example of content may be “company information” or “product information.” A configurable data requirement 26 corresponding to this feature may include certain text and code formatting components for a web page for the content with fields for company name, address, contact person, ingredients, pricing, weight, etc. Based on input supplied by the creator 40, this information may be included in the finished website without requiring the creator 40 to write or edit code.

The DRF 24 provides several stored configurable data requirements 26 in a library to present the various options 56 to the website creator 40 so that the creator 40 may select the appropriate functionality and components of the website. If a specific function and/or component necessary for the website is not found in the library of data requirements 26, two options exists. The first would be to select the closest data requirement 26 to the required function, and to modify the data requirement 26 to meet the website's demands. The second would be to develop a new data requirement 26 from the ‘bare bones’ data requirement 26. Either option would require knowledge and drafting of code.

The DRF 24 is responsible for the specification of web page dependencies on data and ensuring the fulfillment of those data requirements 26. The framework consists of organizing these data requirements 26, assigning them to web pages 48, and configuring them. In addition, the DRF 24 is also responsible for creation/modification of the web page(s) 48 when content in the data requirements 26 is altered, or if data requirements 26 are added to or removed from the DRF 24.

In detail, data requirements 26 are abstractions used to hide the complexities of retrieving data, processing the data, and presenting the result as an output object used by the renderer to generate the markup language data. Each data requirement 26 is generally intended to perform read only operations on data source(s). Since data requirements 26 are an abstraction, they have the luxury of being data source agnostic, meaning they can be used with any data source. Each data requirement 26 is responsible for identifying which inputs 32 (i.e. control 28, preference setting 30, scope 34) the result of the data requirement 26 is dependent on. The most common inputs 32 come through a web page URL via a parameter (e.g. http://www.test.com/?q=search_query). Other inputs 32 can be web browser cookies, server variables, environmental figures, to name a few. The present invention identifies a Control 28, as any input 32 residing within the DRF 24 system, and capable of execution without the need for outside contribution. Preference settings 30 are also inputs 32, however, they differ from a Control 28, in that the require contribution from outside the DRF 24 system in order for it be executed and/or completed. Examples of a Preference setting 30 may include an environmental figure. An environmental figure would include any reference sourced from outside the DRF 24, including information found on the World Wide Web, public and private databases, as well as time, space, and other principles of science.

The scope 34 input allows data requirements 26 to store and retrieve data for use between other data requirements 26. This allows for dependencies between data requirements. For example, a web page may be displaying a customer profile. The first data requirement 26a would be gathering the data required to display the customer profile. Within that customer profile, there might be a list of recent transactions. This second data requirement 26b (list of recent transactions) would be dependent on the first data requirement 26a (customer profile), because it is listing transactions that belong to a customer. The first data requirement 26a would store the customer profile in the scope 34 input and then the second data requirement 26b would reference the customer profile through scope 34 input.

Each data requirement 26 has the ability to further manipulate a default configuration offering options 56 for different types of execution of the data requirement 26 (e.g. A data requirement 26 for retrieving financial transactions could have the option 56 of retrieving all transactions, pending transactions, charged transactions, or voided transactions). These options 56 are identified through the control 28, and may be selected/configured to suit the requirements of the website 46. A control 28 would have the ability to also link up to an input 32. This would allow a default state to be specified, but if there was an input 32 (e.g.http://test.com/transactions?state=pending), then it would modify the default state to the selected option 56, identified in the example as “pending transactions”. This control 28 would be exportable into a configuration format, so that a user interface could be created around it to configure it.

The execution portion of the data requirement 26 is responsible for generating a result and the output portion is responsible for converting that result into an output object. Although not required, the separation of execution and output functionality allows the output portion to modify the execution result based on additional input(s). An example of this would be if the data requirement 26 is responsible for generating a URL to a resource. If the URL had time sensitive information embedded inside it, then it would not be possible to do if it was stored solely in the execution result, because based on caching the result could be referencing a time that has already expired. The output layer would take the execution result (without any time information) and use current timing data to generate a time sensitive URL to a resource. The execution result would have a digital signature based on the data requirement's unique identifier, it's options, and all of the inputs, such that if the exact same data requirement was executed again with the same options and inputs, it would result in the same digital signature. This is primarily used for caching, as is not critical to the overall method described herein. Each data requirement 26 has the ability to specify whether or not its result can be cached. If the result is cacheable, the data requirement is able to provide the cache expiration and digital signature. Finally, all data requirements 26 are registered through a manager 38. This registration allows the manager 38 to be able to provide a list of all of the data requirements 26 available. This is necessary for the user interface that is responsible for assigning data requirements 26 to a web page.

The DRF 24 preferably comprises a software program for use on a computer network. Alternatively, the DRF 24 may be accessed through a suitable network interface. For example, a network browser may be used to access and operate the DRF 24.

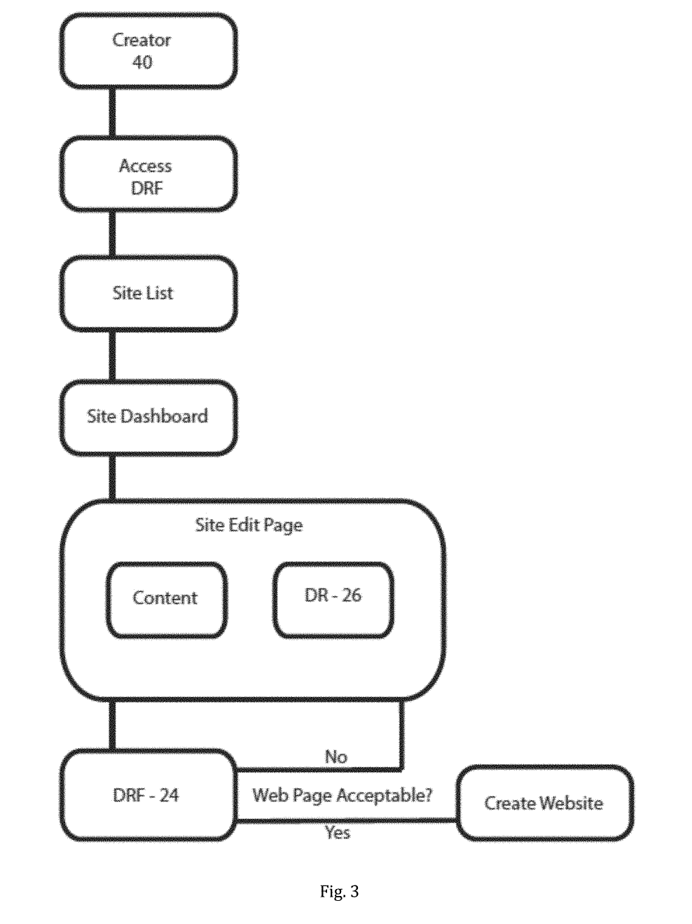

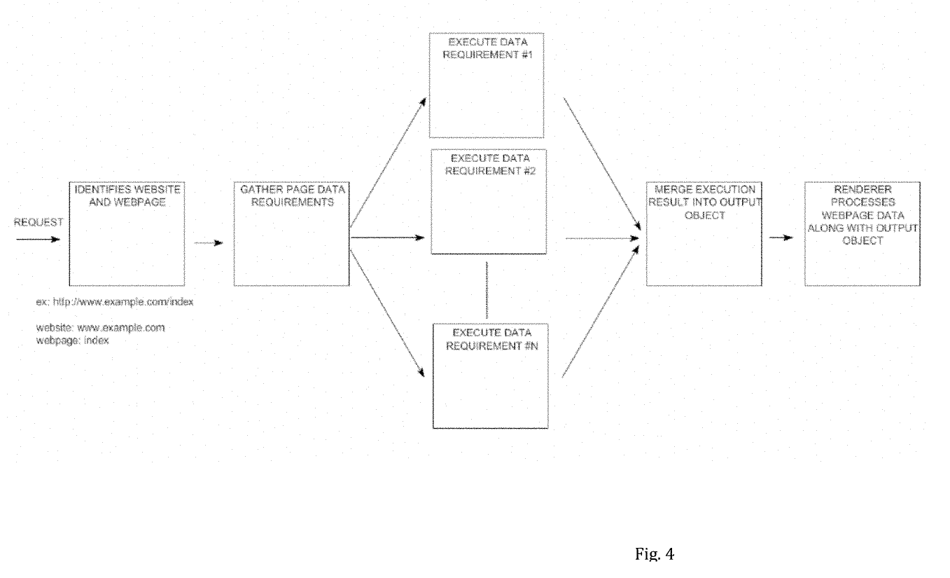

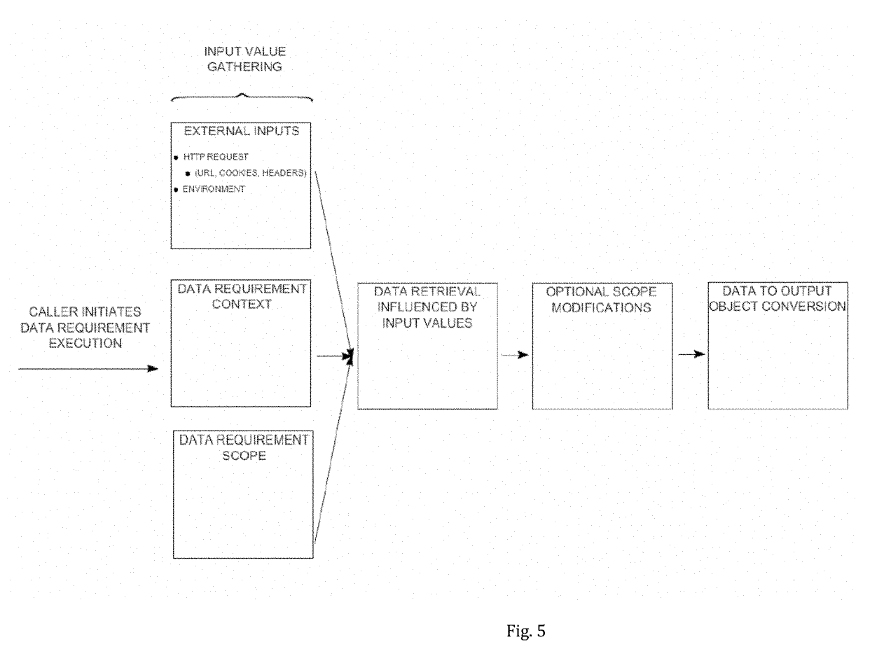

According to one embodiment of the invention, a creator 40 may construct a website in a manner represented in FIG. 3. A creator 40 may start the process, for example, by directing a network browser to access a server, or other network node, on which the DRF 24 is loaded.

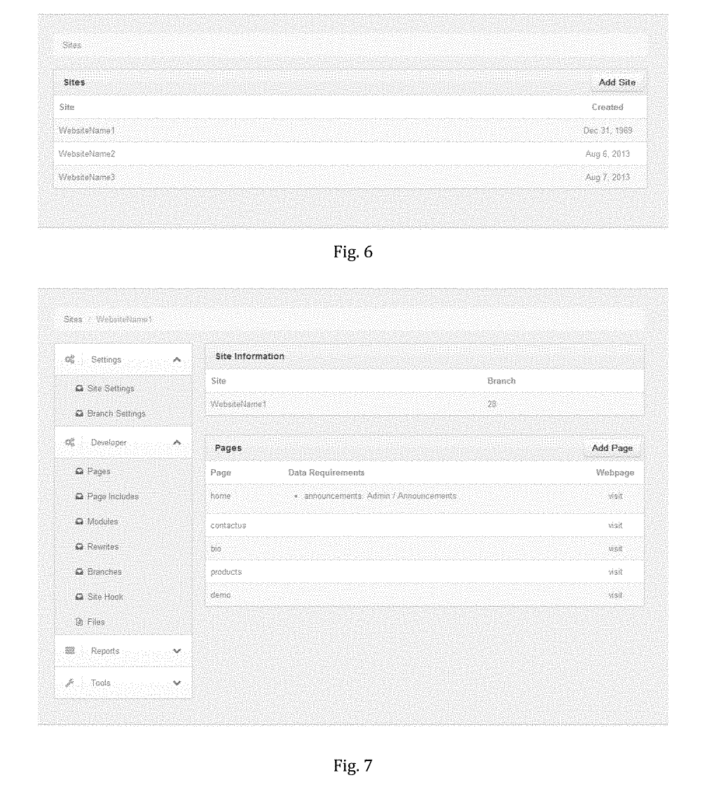

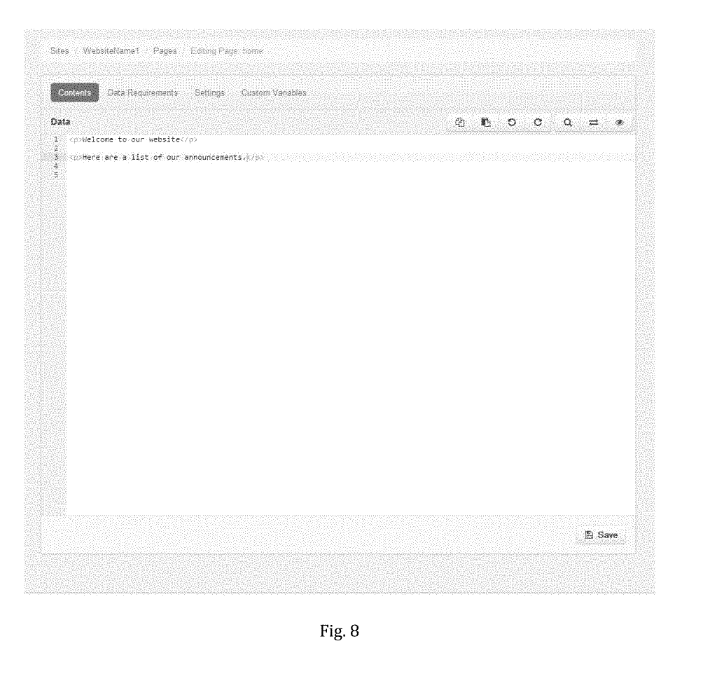

Once the DRF 24 is accessed, a creator 40 is presented with a site list 50 containing one or more websites scheduled for the creator 40 to develop and/or customize (See FIG. 6). Once a website is selected, a site dashboard 52, depicted in FIG. 7, is presented to the creator 40, illustrating configurations and elements of the website to be manipulated by the creator 40. The site dashboard 52 contains settings, developer pages, reporting options, as well as tools for querying and configuring the website. In order to develop a page and add content, the creator 40 selects a button to ‘add page’, then selects the newly added page for development. Upon selecting the desired page to create, a site editing page 54, seen in FIG. 8, is opened for creator 40.

The site editing page 54 contains buttons for editing and adding content and form to the website. The buttons include content, data requirement 26, settings and custom variables. For the purposes of this patent application, only content and data requirements 26 are discussed. Creator 40 may upload or record content he wishes to display onto the site editing page 54 to be configured by the DRF 24. Content may include text, images, links, blogs and other information relevant to the website. Creator 40 may now wish to configure the framework of the page by selecting the data requirement(s) 26 relevant to the functionality and intent of the website. Data requirements 26 may be chosen from a drop down menu, or other similar selection means. Exemplary data requirements 26 may include Company information, Contact information, Customer tracking, Forums, Document repositories, Employee portals, Objects, Frequently asked questions (FAQs), Job Postings, Goods/Services, Project Management and Registration, to list a few.

It is important to note that the order in which tasks are performed in the site editing page 54 is irrelevant, as the order of information obtained is cumulated in building the web page. In instances where specific data requirements 26 are necessary to invoke dependent data requirements 26, such as those through the scope 34 input, proper selection of master to slave data requirements is required.

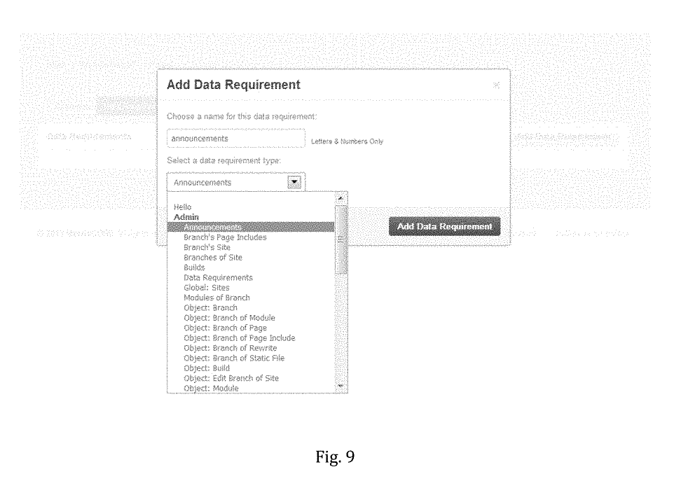

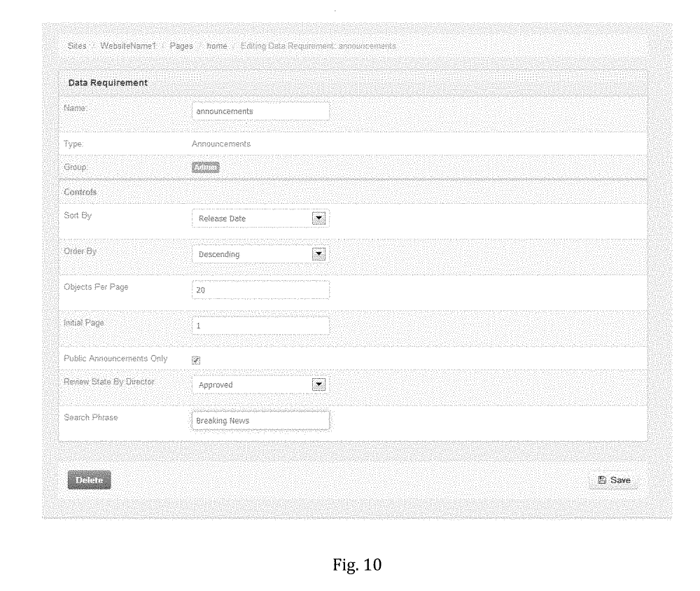

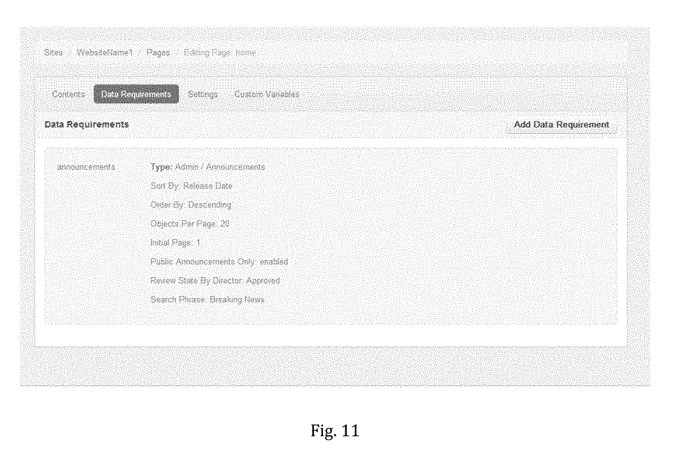

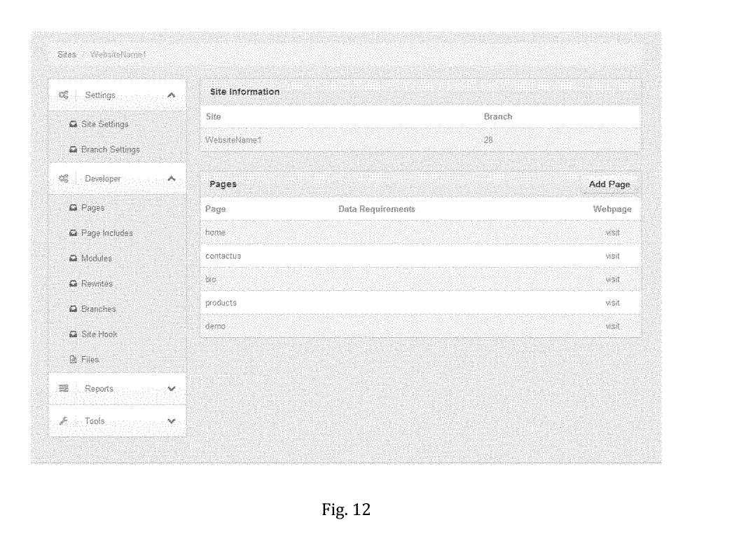

By way of example, FIG. 9 illustrates an embodiment of the drop down menu for selecting data requirement(s) 26. In our example “Announcements” were chosen as the desired data requirement 26. Once a particular data requirement 26 is chosen, the configuration page for the particular data requirement 26 is displayed for the creator 40 to manipulate and amend (see FIG. 10). It is important to note that the configuration page established for each data requirement 26 is specific to that data requirement 26, and contains options 56 specific to the purpose and function of that data requirement 26. Once the parameters for the data requirement 26 are selected by the creator 40, the overall configuration for that data requirement 26 is stored, and may be displayed, as seen in FIG. 11. Now that the creator 40 has chosen and configured a data requirement 26 for a given page in the website, the creator 40 may return to the site dashboard 52 to select and configure the remaining web pages, add data requirement(s) 26, as well as add new web pages, and further manipulate, update, and adjust options 56 for each web page. The uploaded and configured data requirement 26 is depicted on the site dashboard 52 seen in FIG. 12.

Although development and configuration of one page of a website has been detailed above, one can easily extrapolate the development and configuration of an entire website, or multiple websites incorporating the DRF 24. Furthermore, the method by which to amend an existing web page may also be extrapolated from the disclosures provided above. As depicted, the DRF 24 process is completed without code drafting or manipulation, and further provides endless configuration, updating, growth and adaptability options.

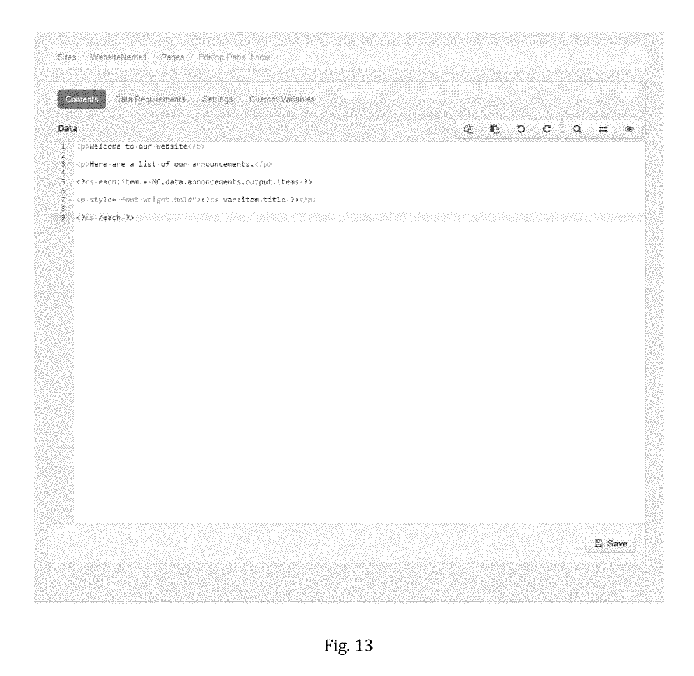

Additionally, the DRF 24 system is configured to allow adaptation of a website or web page by code, should a creator 40 so desire. FIG. 13 illustrates the code behind the system, which is readily accessible to a creator 40, and may be manipulated and/or augmented, if so desired.

What is claimed is:

1. A machine-readable system for developing a website by computer implementation, comprising:
a framework for housing the structure of a website:
a library of data requirements containing data for structuring and relaying context into a website; and
a datasource for providing context to the data requirements;
wherein at least two data requirements join the framework to render a website.

2. The system of claim 1, wherein the data requirement is selected from a group consisting of: Administrative, Affiliates, Attachments, Categories, Content, Extensions, Links, Payment Services, Servers, Users, Websites, derivatives thereof, and combinations therefrom.

3. The system of claim 1, wherein each data requirement may contain at least one option for structuring the data requirement.

4. The system of claim 3, wherein the at least one option is selected by a website creator.

5. The system of claim 3, wherein the at least one option is selected from a group consisting of: order, filter, number, sort, derivatives thereof, and combinations therefrom.

6. The system of claim 1, wherein the system is adapted to be developed by a website creator without the need for web-based programming.

7. The system of claim 1, wherein the system is adapted to be manipulated by a website creator without the need for web-based programming.

8. The system of claim 1, further comprising a manager for registering data requirements in the system.

9. The system of claim 1, further comprising at least one input for structuring the data requirement, wherein the input is selected form a group consisting of an input, control, preference setting, scope, environmental figure, web browser cookie, a server variable, derivatives thereof, and combinations therefrom.

10. A method for developing a website, comprising:
providing a framework upon which a website is developed and configured:
providing a library of data requirements containing data for structuring and relaying context into website;
configuring the data requirements per website requirements; and
joining the data requirements to the framework to complete a website.

11. The method of claim 10, further comprising a machine-readable manner for accessing the framework, library of data requirements, and context.

12. The method of claim 10, further comprising a datasource, in communication with the framework, for uploading context.

13. The method of claim 12, wherein context is selected from the group consisting of text, an image, a link, a blog, a video, derivatives thereof, and combinations therefrom.

14. The method of claim 10, further comprising a website creator, for developing the website, without the need for web-based programming.

15. The method of claim 10, wherein the data requirement is selected from a group consisting of: Administrative, Affiliates, Attachments, Categories, Content, Extensions, Links, Payment Services, Servers, Users, Websites, derivatives thereof, and combinations therefrom.

16. The method of claim 15, wherein each data requirement may contain at least one option for structuring the data requirement.

17. The method of claim 16, wherein the at least one option is selected from a group consisting of an input, control, preference setting, scope, environmental figure, web browser cookie, a server variable, derivatives thereof, and combinations therefrom.

18. The method of claim 10, further comprising a manager for registering data requirements is the system.

19. The method of claim 10, further comprising selecting and configuring a data requirement using context.

20. The method of claim 10, further comprising selecting an option within a data requirement for structuring the data requirement.

21. A system for developing and manipulating a website, comprising:
a computer device comprising:
a central processor;
memory;
an operating system; and
an input/output interface,
a framework for housing the structure of a web page;
context for populating a web page;
a library of data requirements containing data for structuring and relaying context into the web page; and
a presentation layer for relaying the web page created into a web-readable format.
